(19) United States
(12) Patent Application Publication
(10) Pub. No.: US 2015/0298238 A1
(43) Pub. Date: Oct. 22, 2015

(54) ARC WELDING APPARATUS

(71) Applicant: Robo-Arc Consulting (Pty) Ltd, Stellenbosch (ZA)

(72) Inventor: Willem Nicolaas VAN RENSBURG, Stellenbosch (ZA)

(21) Appl. No.: 14/423,419

(22) PCT Filed: Aug. 21, 2013
(86) PCT No.: PCT/IB2013/056773

§ 371 Date: Feb. 23, 2015

(30) Foreign Application Priority Data
Aug. 24, 2012 (ZA) 2012/06374
Jul. 22, 2013 (ZA) 2013/05511

(51) Int. Cl. B23K 9/12

(52) U.S. Cl. CPC B23K 9/121; B23K 9/123

(57) ABSTRACT

Welding apparatus is provided in which welding rods are fed individually in a longitudinal direction along a welding feed path towards a welding site. A feed mechanism includes at least one, and generally two feed carriages (22) having an electrically conductive clamp (36) for transferring electrical energy to a welding rod (32), in use. A reversible drive mechanism (24) moves the feed carriage (22) towards and away from the welding site (31). At least two electrically conductive clamps (36) are movable by feed carriages (22) towards and away from a welding site (31) in use to feed a welding rod (32) engaged by that clamp (36) longitudinally towards the weld site (31). A preloaded replacement welding rod gripped by an electrically conductive clamp (36) in its inoperative position can be moved to its operative position in the welding feed path (28) at the time that another clamp carrying any welding rod stub is moved out of the welding feed path (28).

### FIELD OF THE INVENTION

This invention relates to arc welding apparatus of the type that employs welding rods of a finite length that are typically covered with flux along a major part of their length with the welding rod itself being exposed at one end for connection to an electrical power supply by way of an electrically conductive clamp.

### BACKGROUND TO THE INVENTION

Arc welding apparatus that employs consumable welding rods is widely used for numerous different purposes and especially in heavier duty applications. It is the preferred welding method in many applications such as the fabrication of pressure vessel equipment due to the enhanced weld quality and depth of weld.

Whilst there are other types of welding that generally use either the metal of the work-piece or a consumable metal wire as a filler material, this specification is directed exclusively at the type of welding that employs consumable welding rods covered with a flux material and that is sometimes referred to as stick welding.

Accompanying the advantages of using such consumable welding rods is the disadvantage that successive welding rods must be fed to the operative position in reasonably rapid succession in order to avoid the active weld pool of molten slag from solidifying.

It has been proposed that the feed of welding rods of this type to a work-piece during welding operations be automatic with the welding rods being fed in an end on end relationship. The required speed of feeding an operative welding rod to the arc is dependent on ambient conditions, the thickness and composition of the material being welded, and the speed at which the welding head is moved relative to the work-piece. However, applicant is not aware of any commercially available apparatus of this nature.

One of the main drawbacks of apparatus of the type using welding rods is the fact that when a welding rod has been consumed, the stub that remains needs to be released from the electrically conductive clamp and replaced by a full-length rod in order to continue with a single weld. Such replacement is generally carried out manually and is accompanied by the drawback that the procedure usually takes longer than the period of time for which a molten pool of slag at the weld remains hot enough for an arc to be re-struck and the weld to be continued without cleaning away any solidified slag.

As a result, the procedure is generally to manually discard the residual stub, replace it manually with a full-length welding rod, and, because this generally takes an appreciable length of time, chip away solidified slag before continuing with the weld.

This procedure is therefore time-consuming and also opens up the possibility of a weld having deleterious discontinuities along its length.

U.S. Pat. No. 1,807,961 to Burnish discloses a welding method in which a successive welding rod is fed along a second feed path to a common weld pool and transferring the welding arc from a residual welding rod stub to a succeeding welding rod is achieved by switching a resistor into the circuit of the welding rod stub. No mechanism is described for supporting the welding rods and putting the method into practice.

U.S. Pat. No. 2,504,711 to Lundahl et al discloses an automatic arc welding machine in which a series of welding rods are stacked in a dispensing magazine and are successively engaged and urged along a single welding rod feed path by one of three electrode holders or pistons carried by an endless chain rotating in a single direction. Each electrode holder or person engages an end of a welding rod as it passes the upper ends thereof. It is doubtful that such a proposal could operate in any effective manner.

As another solution to this problem there has been proposed, in our published international patent application number WO2012073090, an arrangement in which multiple welding rods are carried in a special magazine that rotates progressively as each welding rod is consumed to present a fresh welding rod to an electrically conductive clamp for transferring electrical energy to a welding rod, in use, and a reversible drive mechanism for moving a feed carriage carrying the clamp towards and away from the welding site along a single feed path. The apparatus operates effectively but is somewhat complex in its construction.

There is accordingly scope for welding apparatus that will enable a fresh welding rod to be brought into use sufficiently quickly to avoid any solidification of the weld pool that may otherwise interrupt a generally continuous welding process and that may, according to design requirements, be somewhat simplified and require more manual attention.

In this specification is the term welding rod is used in a broad sense and includes all welding rods of finite length that are used successively for creating a weld and that typically have a flux coated onto the outside thereof but that may in other variations, and in particular in future variations, have flux internally within a tubular rod or any other flux arrangement.

### SUMMARY OF THE INVENTION

In accordance with this invention there is provided welding apparatus of the type employing welding rods to effect welding operations, the welding apparatus comprising at least one welding head having a feed mechanism for feeding welding rods individually in a longitudinal direction along a welding feed path towards a welding site, the feed mechanism including at least one feed carriage having an electrically conductive clamp for transferring electrical energy to a welding rod, in use, and a reversible drive mechanism for moving the feed carriage towards and away from the welding site; the welding apparatus being characterised in that it includes at least two electrically conductive clamps each of which is engagable with a welding rod and wherein each of the clamps is movable by a feed carriage towards and away from a welding site in use along a feed path associated with that clamp and directed towards the weld site at least in an operative condition in order to feed a welding rod engaged by that clamp longitudinally towards the weld site; and wherein each clamp has an inoperative withdrawn condition in which any welding rod stub held by the clamp can be discharged and a replacement welding rod introduced into the clamp, the arrangement being such that a preloaded replacement welding rod gripped by an electrically conductive clamp in its inoperative position can be moved to its operative position in the welding feed path at the time that another clamp carrying any welding rod stub is moved out of the welding feed path.

Preferably there is a welding head for each of the clamps that are typically two in number, but there could be more.

In a first variation of the invention, there is a single welding feed path towards the weld site and there are two welding heads each having its own feed path and feed mechanism including a feed carriage and reversible drive mechanism and wherein each welding head and its associated feed mechanism may be physically moved to selectively align the feed path of one of them with the single welding feed path at any one time. In this first variation of the invention the two welding heads and feed mechanisms may be carried on a common base or each may have its own base. In either event the bases can be moved between two terminal positions, one in which the feed path of one welding head is in an operative condition and aligned with the single welding feed path, and another in which the feed path of the other welding head is aligned with the single welding feed path.

The two welding head bases could be mounted in back-to-back relationship and could be movable along a line to selectively align one of the welding heads with the welding feed path. As an alternative, the two welding head bases could be mounted in back-to-back relationship and could be connected together as a unit that is rotatable about an axis generally parallel to the welding feed path so that one welding head base may be positioned such that a welding rod therein is aligned with the welding feed path at any one time. In this variation of the invention in the welding arc will become extinguished when the welding rod stub is removed from the welding site and needs to be struck again when the replacement welding rod is in its operative position

In a second variation of the invention each welding head has its own feed mechanism including a feed carriage and reversible drive mechanism supported on a base with the two bases being pivotally attached to a common, optionally mobile, carrier that may be guided for movement along a predetermined welding path relative to a workpiece. In such an instance, each of the bases can be tilted to align a replacement welding rod in the feed path of that welding head with the weld site whilst that welding head is in an inoperative condition and at the same time as an operative welding rod is supported by the other welding head in its operative condition and in use. In this second variation of the invention it is possible to cause a transfer of the welding arc from the welding rod stub to the replacement welding rod without interruption of the welding activity.

Other features of the second variation of the invention provide for each of the bases to have tilt motors associated therewith for tilting the base and its associated feed carriage and drive mechanism so that a welding rod held by the associated clamp is inclined to a workpiece and directed at the weld site whilst a welding rod held by the other welding head extends generally perpendicular to the workpiece. In such an instance when an arc has been transferred from the almost spent operative welding rod stub to the replacement welding rod, the weld head associated with the welding rod stub is withdrawn from the workpiece and the tilt motor associated with the replacement welding rod will move the base of the welding head so that the replacement welding rod extends at generally right angles to the workpiece.

In a third variation of the invention two welding heads, each of which has its own feed mechanism including a feed carriage and a reversible drive mechanism, are mounted on a common base with the feed paths of the two are inclined somewhat relative to each other such that they intersect at a position that corresponds with the position of the weld site in use. The base may be movable between positions in which an operative welding rod is generally perpendicular to the workpiece. It is, however, also envisaged that the welding rods may remain inclined to the workpiece if the base on which they are mounted is not appropriately movable between terminal positions in which the operative welding rod is perpendicular to the workpiece. In this third variation of the invention it is also possible to cause a transfer of the welding arc from the welding rod stub to the replacement welding rod without interruption of the welding activity.

Further features of the invention provide for the reversible drive mechanism in each instance to include a reversible endless drive belt or chain or a lead screw; for each feed carriage to be longitudinally movable on one or more rails therefor; for the reversible drive mechanism to include a feed drive servo motor; and for each welding apparatus to be configured to be supported by a transport carriage for moving the welding apparatus over a surface of a workpiece, especially in relation to a track provided on the surface of the workpiece and that may be removable therefrom.

Still further features of the invention provide for the welding apparatus to have a clamp releasing mechanism for releasing each electrically conductive clamp to disengage any welding rod or, in particular, a welding rod stub, that may be gripped thereby and for re-engaging the clamp with a replacement welding rod that is to be movable longitudinally in the feed path of that particular feed mechanism; and for the apparatus to include a magazine for holding a supply of replacement welding rods together with a suitable pick and place mechanism for removing a welding rod from the magazine and placing it in association with a relevant clamp in which instance the clamp releasing mechanism operates automatically to discharge a welding rod stub and re-engage it with a replacement welding rod.

Yet additional features of the invention provide for a guide shoe to be provided for locating and guiding an end of a welding rod nearer a weld site with the guide shoe having at least one aperture through it for receiving the welding rod; for the guide shoe to be movable between a normal operating position in which it is spaced somewhat from the weld site and a terminal position in which it is closer to the weld site to enable maximum usage to be derived from a welding rod and also to enable a replacement welding rod to be installed in the associated clamp with the welding rod passing through an aperture in the guide shoe; and for a mechanism to be provided for moving the guide shoe between the normal operating position and its said terminal position at least during installation of the replacement welding rod.

The welding apparatus may form part of dedicated welding apparatus designed for specific purposes, especially, but not exclusively, welding apparatus for butt welding ends of relatively large diameter pipes together.

In order that the above and other features of the invention may be more fully understood various embodiments of the welding apparatus according to the invention will now be described with reference to the accompanying drawings.

### BRIEF DESCRIPTION OF THE DRAWINGS

In the drawings:—

FIG. 1 is a schematic elevation of one proposed embodiment of the first variation of the invention in which two welding heads are positioned next to each other on a mounting track therefor for selective alignment with a single welding feed path;

FIG. 2 is a schematic elevation of one proposed embodiment of the second variation of the invention in which two welding heads are each mounted on separate bases that are pivotally attached to a carrier so as to permit tilting thereof;

FIG. 3 is a schematic elevation of one proposed embodiment of the third variation of the invention in which two welding heads are mounted to a single base with their feed paths inclined to each other to intersect at a weld site on a workpiece;

FIG. 4 is a three-dimensional view from the one side showing more detail of one particular embodiment of the second variation of the invention;

FIG. 5 is an enlarged three-dimensional view of the two welding rod feed assemblies next to each other and showing the one with an almost spent welding rod stub;

FIGS. 6a, 6b, 6c and 6d illustrate in three steps the changeover from a welding rod stub held by the left-hand feed assembly to a replacement welding rod held by the right-hand feed assembly;

FIG. 7 is a side three-dimensional view from the rear of the two welding rod feed assemblies showing the tilt drive arrangement;

FIG. 8 is a three-dimensional illustration showing the biasing of the guide shoe support mechanism;

FIG. 9 is a detail showing one form of manually releasable clamp assembly;

FIG. 10 is a detail showing parts of a feed drive mechanism;

FIG. 11 is a three-dimensional view showing a variation of the embodiment illustrated in FIGS. 4 to 10 wherein an automatic welding rod replacement mechanism has been added;

FIG. 12 is a three-dimensional illustration from the front of the welding rod replacement mechanism showing details thereof;

FIG. 13 is an underneath view of a welding rod clamp assembly for automatic operation in the clamped or closed condition;

FIG. 14 is the same as FIG. 14 showing the clamp assembly in the open condition;

FIG. 15 is a three-dimensional illustration of the clamp assembly in the open condition;

FIG. 16 is a block diagram of an electrical control circuit suitable for use in welding apparatus of the type illustrated in FIGS. 5 to 15; and,

FIG. 17 is a three-dimensional illustration showing a grinder added to the welding apparatus.

### DETAILED DESCRIPTION WITH REFERENCE TO THE DRAWINGS

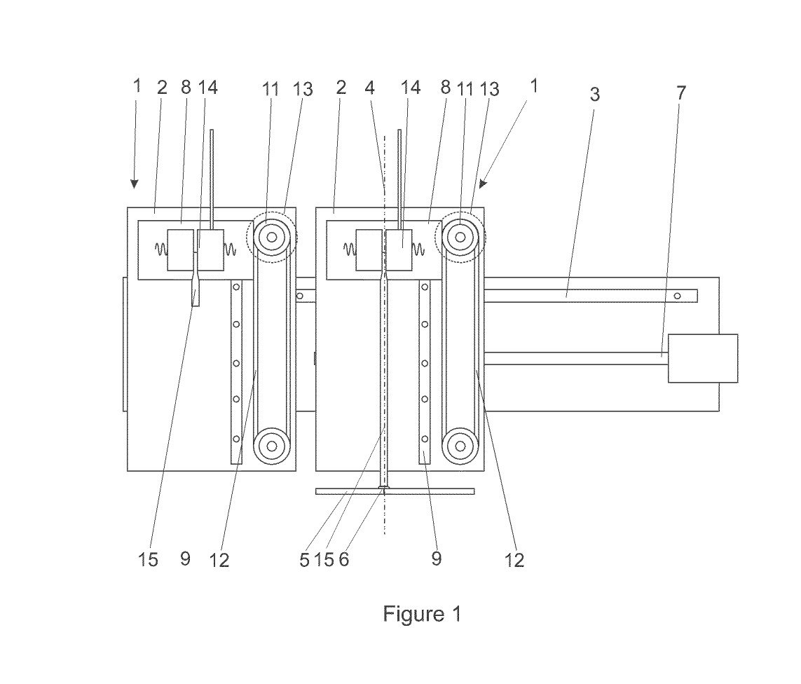

In the embodiment of the first variation of the invention that is illustrated in FIG. 1 of the drawings, welding apparatus of the type employing welding rods coated with flux material to effect welding operations has two welding head assemblies (1) each of which has its own welding head base (2) mounted on a common supporting mounting track (3). The welding heads can thus be moved into and out of alignment selectively with a welding feed path that is indicated by numeral (4) that is directed in use towards a weld site on a workpiece (5) so that, in operation, a weld pool (6) is formed in the usual way during welding operations.

The welding head bases are positioned next to each other on the common supporting mounting track such that they may be moved interchangeably into registration with the welding feed path so as to be in line with the weld pool, the movement being effected by a suitable transfer drive mechanism (7) that is typically an endless chain or belt, or alternatively, a lead screw or worm gear drive.

Each of the welding head assemblies has its own feed mechanism that includes a feed carriage (8) movable longitudinally along the rail (9) fixed to the welding head base and a reversible drive mechanism (11) that in this instance includes an endless belt or chain (12) and a suitable servo drive motor (13) mounted on the welding head base. Each welding head assembly also has an electrically conductive clamp (14) carried by the feed carriage for transferring electrical energy to a welding rod (15) engaged by it, in use.

The supporting track may be carried by a transport carriage (not specifically illustrated) for moving the welding apparatus over a surface of a workpiece, especially in relation to a track provided on the surface of the workpiece.

It will be understood that, in use, welding may be conducted in the usual way with a welding rod (15) being moved longitudinally towards the workpiece by the feed mechanism. Once a welding rod that is associated with the currently active welding head assembly has been consumed, the feed mechanism can initiate withdrawal of the welding rod stub from the weld site. Whilst the welding rod stub is still being withdrawn, the transfer drive mechanism can move the two welding head assemblies along the supporting mounting track so that the formerly inactive welding head assembly is moved into alignment with the welding feed path and immediately welding can continue without the molten weld pool in any way commencing solidification.

A welding rod stub held by the clamp of the now inactive weld head assembly can be discharged, either manually or automatically, and a replacement welding rod introduced into the relevant clamp.

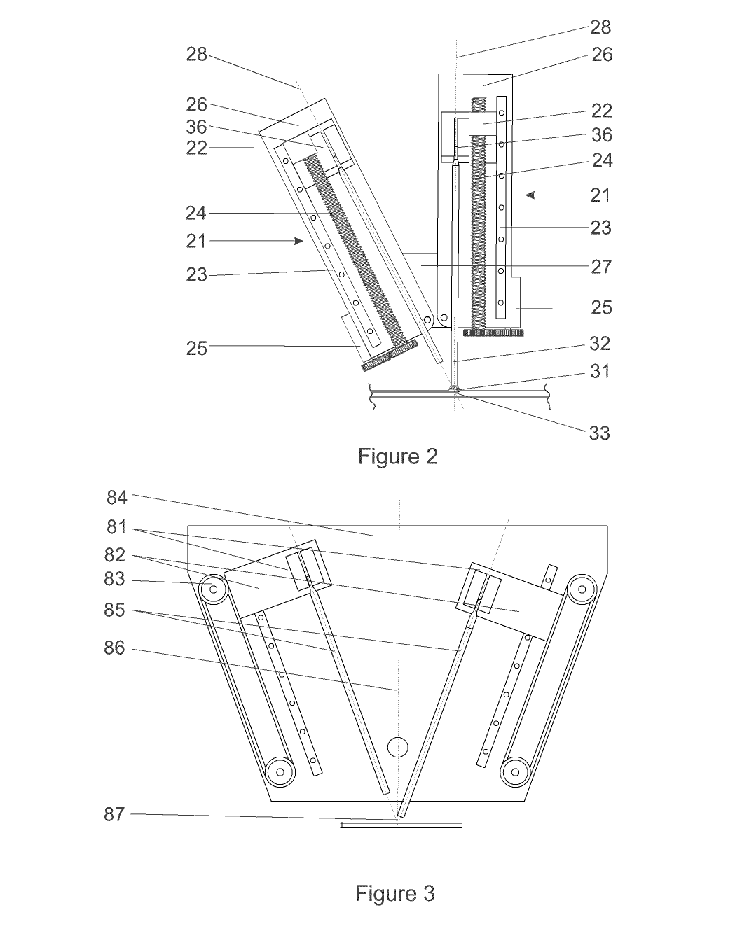

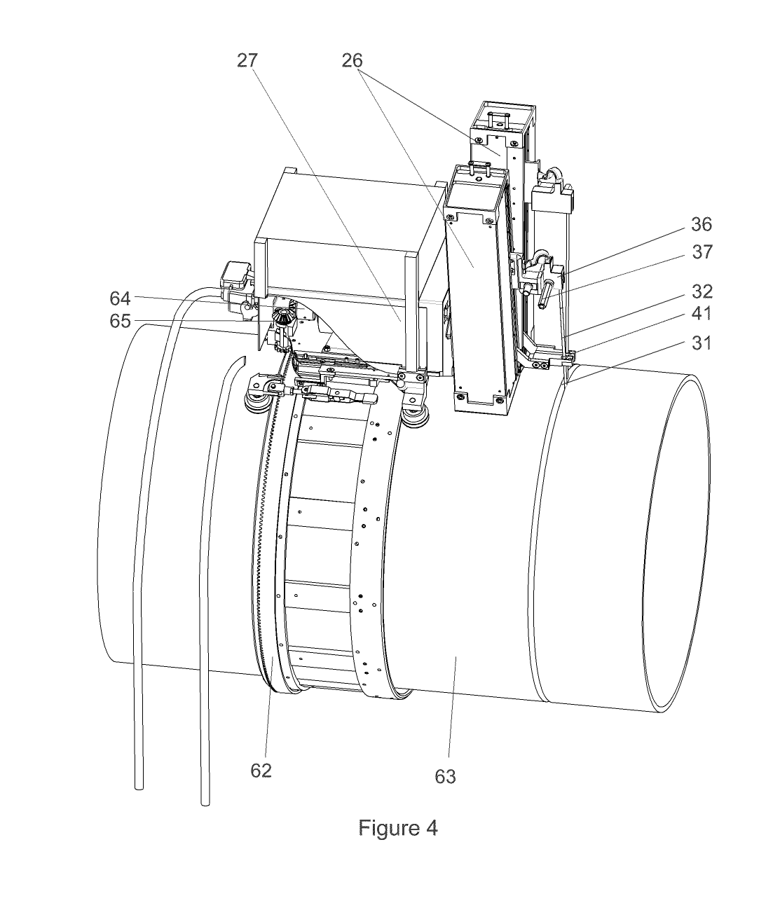

Reference is now made to the schematic illustration of FIG. 2 of the drawings and the greater detail of one particular embodiment of the second variation of the invention that is illustrated in FIGS. 4 to 15 of the drawings. In this second variation of the invention the welding apparatus has two welding head assemblies (21) each with its own feed mechanism including a feed carriage (22) movable along one or more rails (23) and a reversible drive mechanism, in this instance in the form of a lead screw (24) driven by a feed servo motor (25), with all of the components being supported on a base (26). The two bases (26) are each pivotally attached to a common, optionally mobile, transport carriage (27) that may be guided for movement along a predetermined path by one or more rails fixed to a workpiece, as will be further described below.

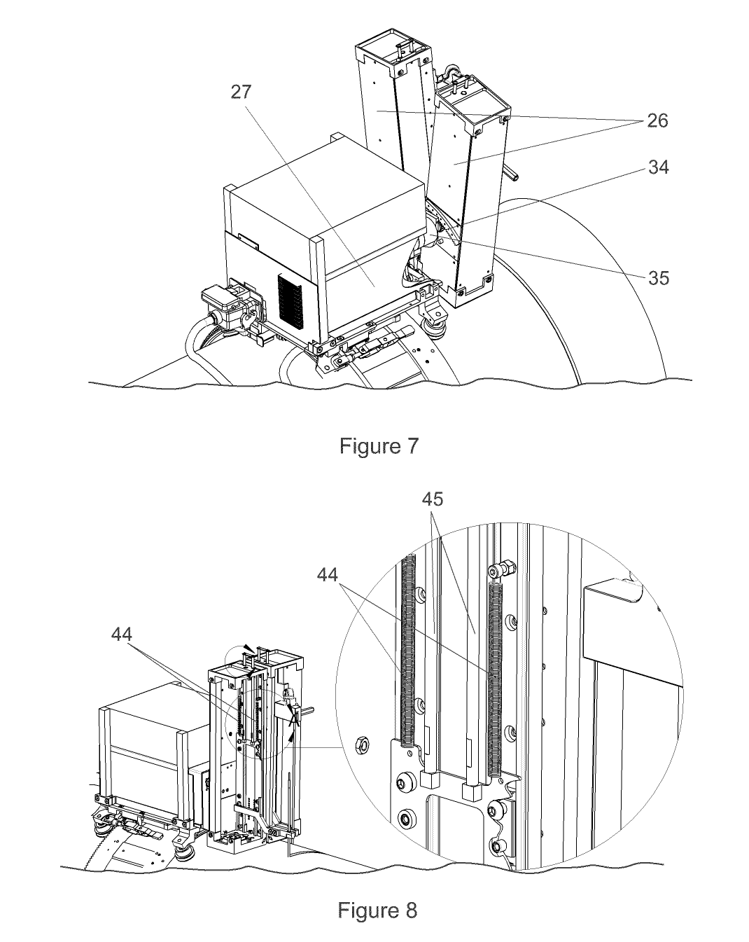

Each of the bases is pivotally attached to the carrier so that it can be tilted to align the feed path (28) of an inoperative welding head with the weld site or weld pool (31) whilst that welding head in an inoperative condition and whilst a welding rod (32) supported by the other welding head is in its operative condition and in use and conducting arc welding on the workpiece (33). In the present embodiment of the invention, the welding rods are adapted to extend perpendicular to the workpiece (33) during normal welding activity but to approach the weld pool at an incline preparatory to taking over the arc from the operative welding rod. With particular reference to FIG. 7, each of the bases are provided, in this embodiment of the invention, with a tilting mechanism composed of an arcuate rack (34) attached to the relevant base (26) and driven by a reversible tilt motor (35).

The arrangement is such that once an arc has been transferred from an almost spent welding rod stub to a replacement welding rod, the weld head associated with the welding rod stub may be withdrawn from the workpiece and the tilt motor associated with the replacement welding rod will move the base of that welding head so that the replacement welding rod moves into a position in which it is approximately perpendicular to the workpiece.

In a simple, somewhat manually operable form of the embodiment of the second variation of the invention illustrated in FIGS. 4 to 10 of the drawings, each welding head has a manually releasable electrically conductive clamp (36) for gripping the conductive end of a welding rod. Manual operation can be achieved, for example, simply by rotating an operating handle (37) projecting from the clamp assembly. Operation of the clamp can thus be used to release a welding rod stub that may be gripped thereby, and to engage a replacement welding rod that is to be movable longitudinally in the feed path of that particular feed mechanism.

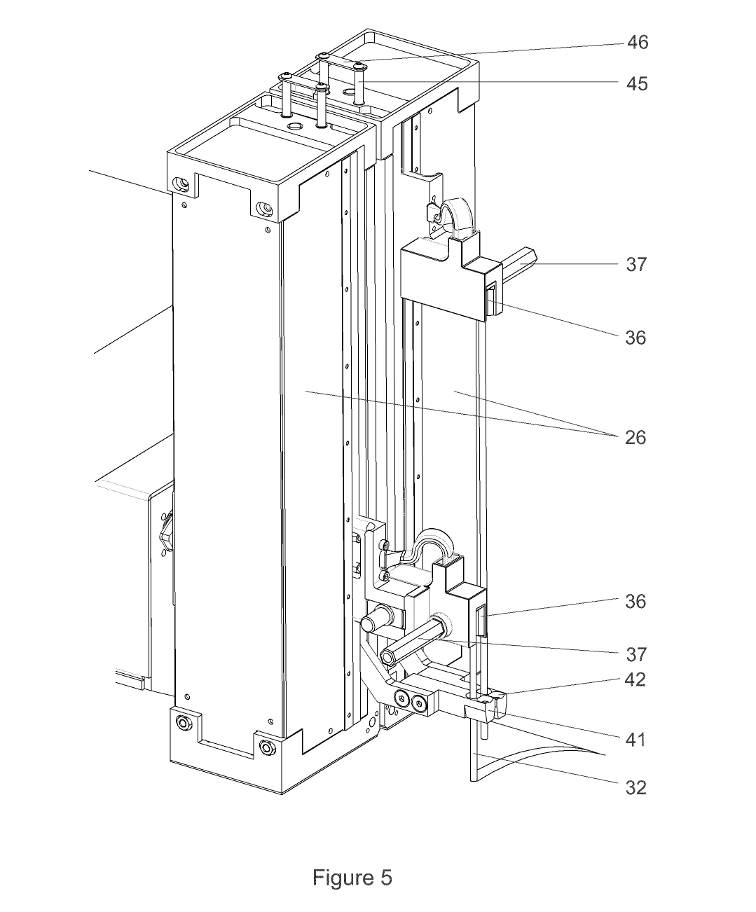

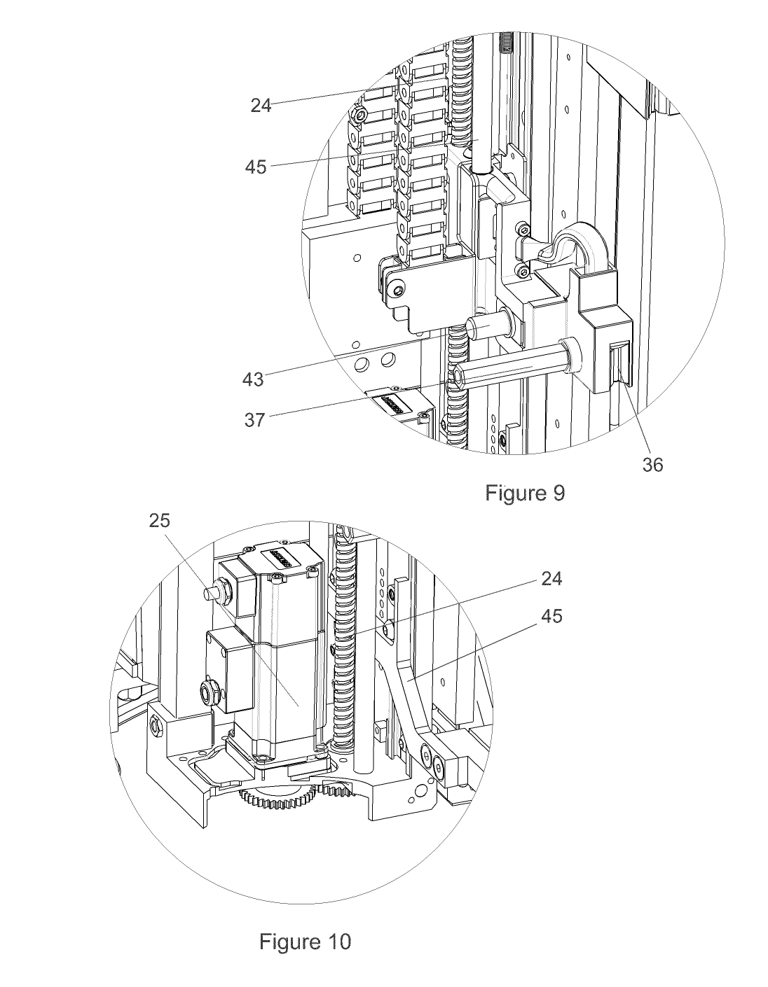

A guide shoe (41) is provided towards the end of the feed path nearer the workpiece for locating and guiding an end of a welding rod nearer a weld site or weld pool. The guide shoe has, in this instance, two apertures (42) through the shoe, one being of somewhat smaller diameter for smaller diameter welding rods and the other being of a larger diameter for larger diameter welding rods (see FIG. 5 in particular). Of course, in instances in which two apertures are provided, the clamp must either be provided with two clamping positions or the clamp itself must be movable between two terminal positions one of which corresponds to each of the apertures which is the option selected in this particular instance. The mechanism is generally indicated by numeral (43) in FIG. 9.

The guide shoe arrangement is such that a guide shoe is spaced sufficiently from the weld site to avoid being adversely affected by the welding arc during at least most of the time during which a welding rod is consumed. The guide shoe may be of a suitable metal or ceramic material or a ceramic coated metal.

Each guide shoe is, however, movable between its normal operating position in which it is spaced somewhat from the weld site and a terminal position in which it is somewhat closer to the weld site. In the latter position the guide shoe is located so as to receive an end of a replacement welding rod when it is installed in position. Also, the guide shoe is biased to its normal operating position by means of suitable tension springs (44) acting on a longitudinally extending support (45) (see FIG. 8 in particular). This arrangement enables maximum usage to be derived from a welding rod by the shoe being engaged by the clamp approaching the weld site to enable the welding stub to become as short as may be practical with the guide shoe moving downwards against the action of the tension springs.

The arrangement also enables a replacement welding rod to be installed in the associated electrically conductive clamp such that the end of the welding rod remote from the clamp can be passed through its appropriate aperture in the guide shoe. A mechanism is provided for moving the guide shoe between the normal operating position and its said terminal position at least during installation of a replacement welding rod. In the instance of the more manually operable welding apparatus, the longitudinally extending support (45) has remote ends projecting out of the welding head assembly remote from the weld site and the ends are connected together by a transverse handle (46) (see FIG. 5) that can be manually operated in order to move the guide shoe towards the workpiece against the action of the tension springs (44).

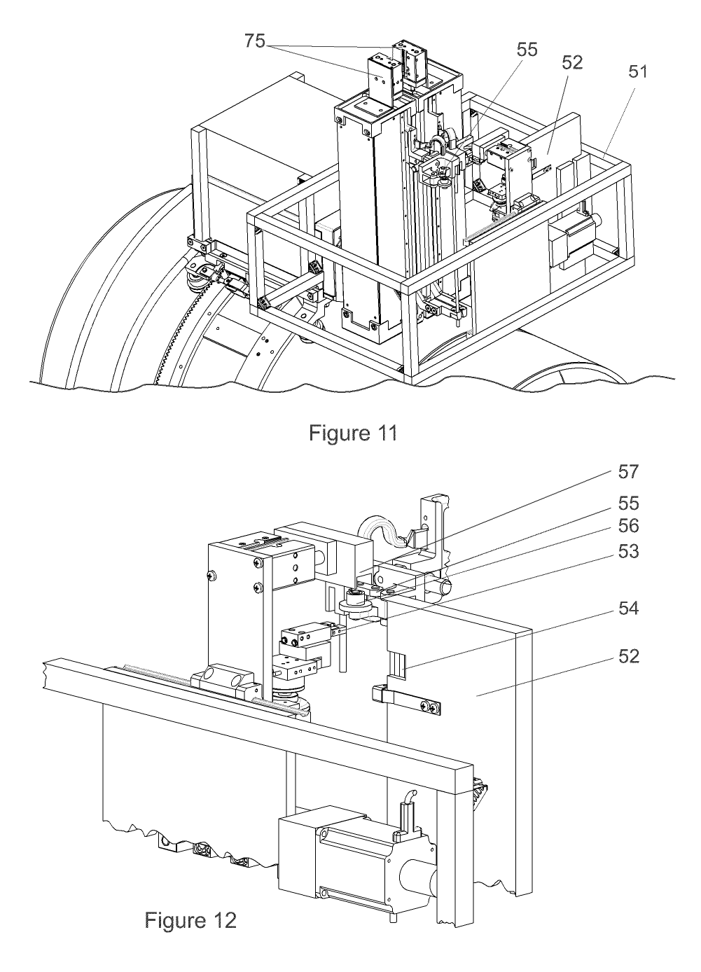

In the more automatic version of the embodiment of the second variation of the invention the relevant portions of which are illustrated FIGS. 11 to 15, the welding apparatus includes a forwardly projecting frame (51) that supports, towards one side thereof, a magazine (52) for holding a supply of replacement welding rods, typically in a single layer. The frame also supports a suitable pick and place mechanism for removing a welding rod from the magazine and placing it in association with a relevant clamp. The pick and place mechanism may be of any suitable design and will generally include grippers (53) for top and bottom regions of a welding rod that can be accessed by way of cut-outs (54) in the front edge region of the magazine. A suitable mechanism for selectively moving the grippers into association with either one of the welding head assemblies is also provided.

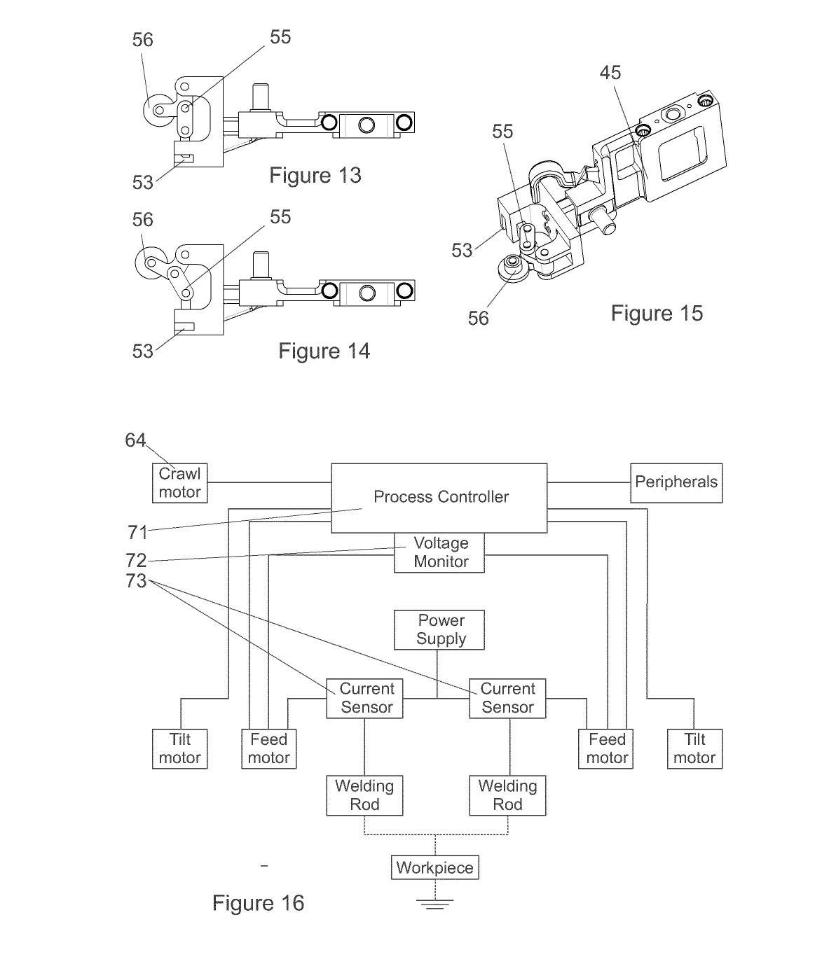

In this arrangement each clamp is provided with a suitable mechanism for releasing the clamp to discharge a welding rod stub and re-engage it with a replacement welding rod. A suitable arrangement is considered to be one in which the clamp has an over-centre lock (generally indicated by numeral (55)) for locking it in the engaged position which is illustrated in FIG. 13 and releasing it to a disengaged position which is illustrated in FIGS. 14 and 15. An operating formation (56) is provided for cooperation with a retractable release member (57) having a cooperating formation that can conveniently be in the form of a transverse channel so that only one channel is needed to cooperate with either of the operating formations of the two welding head assemblies. It is to be noted that only one welding head assembly would ever be at a sufficiently remote position relative to the workpiece to be engaged by such a channel.

Whilst there are numerous applications for welding apparatus according to the invention, simply by way of example, the welding apparatus may be configured to be supported by the transport carriage (27) for moving the apparatus over a surface of a workpiece. In the illustrated embodiment of the invention, a track (62) in the form of a rack is provided on the surface of the workpiece and that may be removable therefrom. The workpiece may be a large diameter pipe (63) being butt welded to another pipe with the track encircling the outer surface of the pipe adjacent an end thereof. A crawl motor (64) and suitable gear arrangement (65) may be used to move the transport carriage along the track (see FIG. 4 in particular).

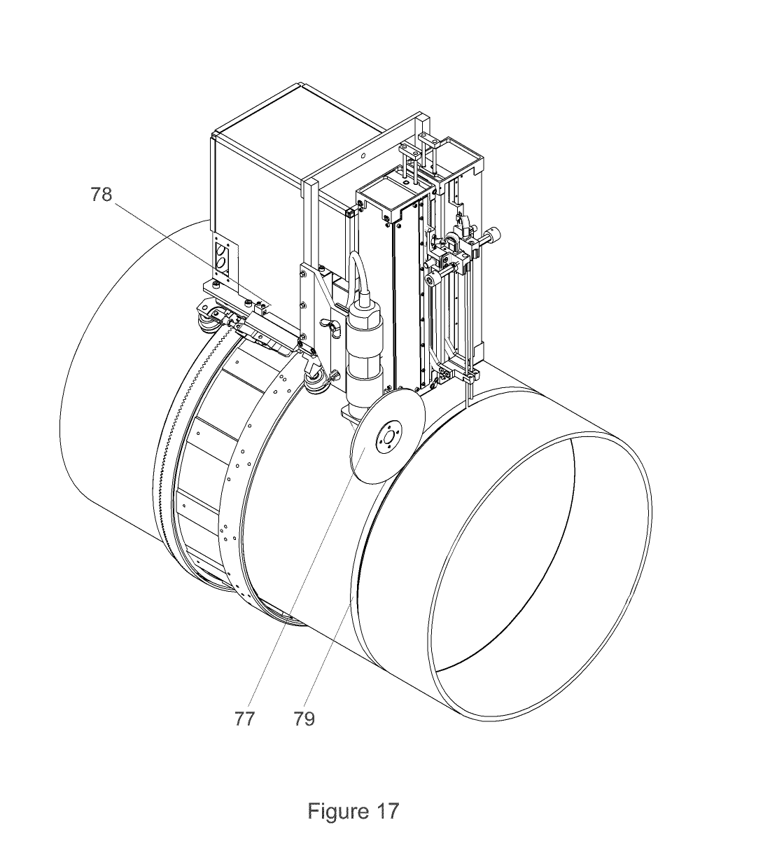

With reference to FIG. 16 of the drawings, the electrical and control arrangement of the welding apparatus may conveniently include a computerised controller (71) associated with a voltage monitor (72) and connected to two independent current sensors (73), one for each weld head. The computerized controller is programmed to control any crawl motor, the welding rod feed motors, the tilt motors and any automatic welding rod replacement mechanism.

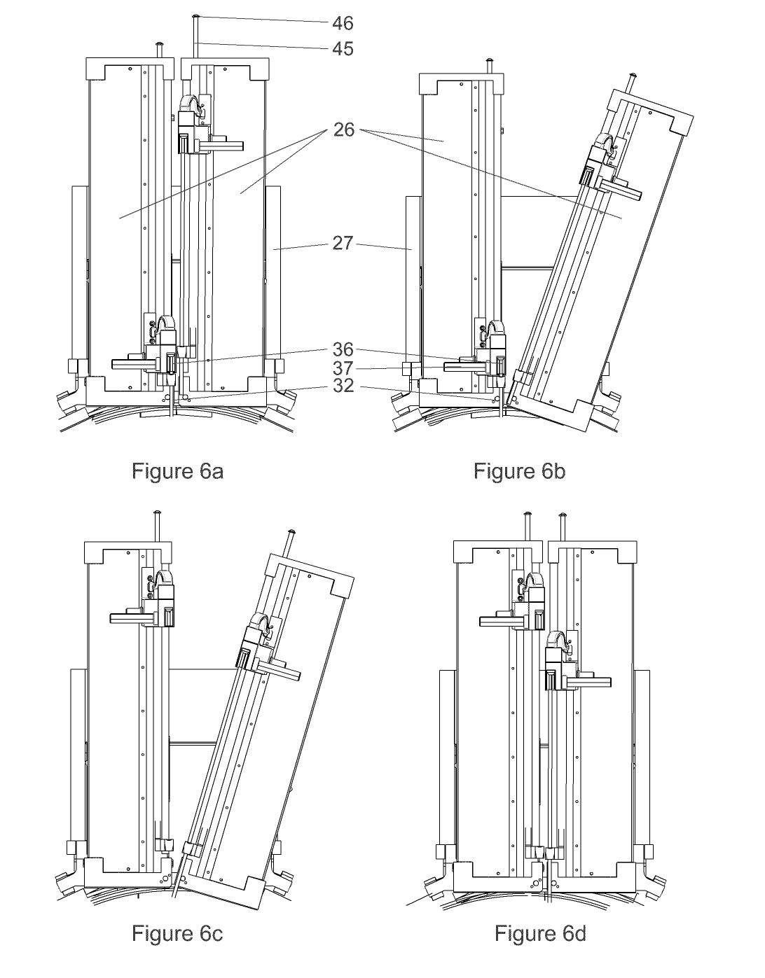

Once a replacement welding rod has been installed in its welding head such as the right-hand one illustrated in FIG. 6a, the associated tilt motor is operated to move the welding head to its takeover position that is at an incline to the workpiece and as shown in FIG. 6b. The replacement welding rod is then moved axially by the feed motor to a position sufficiently close to the weld pool at which stage the welding head waits until that replacement welding rod takes over the arc of the spent welding rod. As soon as the current sensor associated with the replacement welding rod detects a current flowing through its associated power supply cable, its servo feed motor starts feeding the welding rod longitudinally towards the weld pool. The feeding speed is precisely controlled via the voltage monitor card associated with the computerized controller. Control is exercised in a manner aimed at maintaining a target voltage, for example in say 24 V in the event that a 4.2 mm diameter welding rod is employed. If the arc gap increases, the voltage will drop and the feed motor is controlled to feed faster. On the other hand, if the arc gap decreases, the voltage increases and the motor is controlled to feed more slowly.

After the arc has been taken over by the replacement welding rod, the spent welding rod is withdrawn, as shown in FIG. 6c, and the weld head carrying the now active replacement welding rod is tilted back to its original position in which the welding rod is perpendicular to the work-piece as shown in FIG. 6d. In order to insert a new replacement welding rod in the withdrawn weld head, in the instance of the manual operation, with the clamp disengaged, the handle is pushed down in order to increase the space between the clamp and the guide shoe to permit the entrance of a full-length replacement welding rod into its operative position. The handle is released and clamp is tightened. As the handle is released the replacement welding rod is to pass through the appropriate aperture in the guide shoe as the guide shoe rises under the action of the tension springs.

In the instance of the more automatic replacement of welding rods, a pick and place mechanism operates and the guide shoes are moved towards the workpiece by a pneumatic piston cylinder assembly (75) acting on the upper ends of the guide shoe support (45) (see FIG. 11).

It is to be noted that in the instance of a large diameter pipe being butt welded to another length large diameter of pipe, and as shown in FIG. 17, the welding apparatus may include at least one of grinding wheel (77) carried by the transport carriage assembly (78) and that can grind away slag forming consequent on the welding operation. The advantage of this arrangement is that multiple passes can be carried out so as to build up the weld material in a generally Vee-shaped groove (79) at the butt joint of the two pipe ends by successive passes of the welding head along the groove that builds up the weld metal progressively.

In a third variation of the invention that is shown in FIG. 3 of the drawings two welding heads (81), each of which has its own feed mechanism including a feed carriage (82) and a reversible drive mechanism (83), are mounted on a common base (84) with the feed paths (85) of the two feed paths inclined somewhat relative to each other and equally inclined relative to a perpendicular (86). The feed paths intersect at a position (87) that corresponds with the position of the weld site in use. The base may be movable between positions in which an operative working electrode is generally perpendicular to the workpiece. It is, however, also envisaged that the welding rods may remain inclined to the workpiece.

As will be understood that numerous variations may be made to the embodiments of the invention described above without departing from the scope hereof. The movement whereby one clamp can be moved into alignment with the feed path whilst the other is moved out of alignment with the feed path can be achieved in numerous different ways and with numerous different movements and mountings of the various components.

1. Welding apparatus of the type employing welding rods to effect welding operations, the welding apparatus comprising at least two welding heads each having a feed mechanism for feeding welding rods individually in a longitudinal direction along a welding feed path towards a welding site, each feed mechanism including a feed carriage having an electrically conductive clamp for transferring electrical energy to a welding rod, in use, and a reversible drive mechanism for moving the feed carriage towards and away from the welding site along a feed path associated with that clamp and directed towards the weld site at least in an operative condition in order to feed a welding rod engaged by that clamp longitudinally towards the weld site; and wherein each clamp has an inoperative withdrawn condition in which any welding rod stub held by the clamp can be discharged and a replacement welding rod introduced into the clamp, the arrangement being such that a preloaded replacement welding rod gripped by an electrically conductive clamp in its inoperative position can be moved to its operative position in the welding feed path at the time that another clamp carrying any welding rod stub is moved out of the welding feed path wherein each clamp and any associated welding rod is movable along its feed path in a direction that is perpendicular to the weld site during operative feeding of the welding rod towards the weld site and wherein each feed carriage is supported on a base pivotally attached to a common, optionally mobile, carrier that may be guided for movement along a predetermined welding path relative to a workpiece and wherein each of the bases can be tilted to align a replacement welding rod in the feed path of that welding head with the weld site whilst that welding head is in an inoperative condition at the same time as an operative welding rod is supported by the other welding head in its operative condition and is in use; wherein each of the bases has a tilt motor associated therewith for tilting the base and its associated feed carriage and drive mechanism so that a welding rod held by the associated clamp is inclined to a workpiece and directed at the weld site whilst a welding rod held by the other welding head extends generally perpendicular to the workpiece wherein the arrangement is such that when an arc has been transferred from the almost spent operative welding rod stub to the replacement welding rod, the weld head associated with the welding rod stub is withdrawn from the workpiece and the tilt motor associated with the replacement welding rod moves the base of the welding head so that the replacement welding rod extends at generally right angles to the workpiece.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. Welding apparatus as claimed in claim 1 in which the reversible drive mechanism in each instance is selected from a reversible endless drive belt or chain and a lead screw.

14. Welding apparatus as claimed in claim 1 in which each feed carriage is longitudinally movable on one or more rails therefor.

15. Welding apparatus as claimed in claim 1 in which the welding apparatus is associated with a transport carriage for moving the welding apparatus over a surface of a workpiece in relation to a track provided on the surface of the workpiece and that may be optionally removable therefrom.

16. Welding apparatus as claimed in claim 1 in which the welding apparatus has a clamp releasing mechanism for releasing each electrically conductive clamp to disengage any welding rod or welding rod stub that may be gripped thereby and for re-engaging the clamp with a replacement welding rod that is to be movable longitudinally in the feed path of that particular feed mechanism and the apparatus includes a magazine for holding a supply of replacement welding rods together with a suitable pick and place mechanism for removing a welding rod from the magazine and placing it in association with a relevant clamp in which instance the clamp releasing mechanism operates automatically to discharge a welding rod stub and re-engage it with a replacement welding rod.

17. Welding apparatus as claimed in claim 1 in which a guide shoe is provided for locating and guiding an end of a welding rod nearer a weld site with the guide shoe having at least one aperture through it for receiving the welding rod wherein the guide shoe is movable between a normal operating position in which it is spaced somewhat from the weld site and a terminal position in which it is closer to the weld site to enable a replacement welding rod to be installed in the associated clamp with the welding rod passing through an aperture in the guide shoe wherein a mechanism is provided for moving the guide shoe between the normal operating position and its said terminal position at least during installation of the replacement welding rod.
